(19) United States
(12) Patent Application Publication
(10) Pub. No.: US 2026/0284809 A1
(43) Pub. Date: Sep. 24, 2026

(54) VEHICLE MEMBER ASSEMBLY AND METHOD FOR MANUFACTURING THE SAME

(71) Applicant: MAGNA INTERNATIONAL INC., AURORA, ONTARIO (CA)

(72) Inventor: Stephan KAUFHOLD, Sailauf, Bavaria (DE)

(21) Appl. No.: 19/473,477

(22) PCT Filed: Apr. 16, 2024
(86) PCT No.: PCT/IB2024/053720

§ 371 Date: Oct. 7, 2025

Related U.S. Application Data
(60) Provisional application No. 63/459,884, filed on Apr. 17, 2023.

(51) Int. Cl. B23P 15/00; B21D 22/02; B23K 20/12; B23K 26/346; B23K 26/38

(52) U.S. Cl. CPC B23P 15/00; B21D 22/022; B23K 20/1265; B23K 26/346; B23K 26/38; B23P 2700/50

(57) ABSTRACT

A method for forming a vehicle member assembly for use in an automobile comprises providing a plurality of vehicle blank members, each vehicle blank member comprising aluminum; welding each of the vehicle blank members to at least an adjacent vehicle blank member by friction stir welding to form weld joints between each of the vehicle blank members and at least the adjacent vehicle blank member so as to form a vehicle blank member assembly; and shaping the vehicle blank member assembly into a desired shape. At least a portion of each weld joint comprises equiaxed, recrystallized grains that are flatter and smaller in comparison with grains of microstructure of portions of the vehicle blank members surrounding the weld joint.

### CROSS REFERENCE TO RELATED APPLICATIONS

This application claims the benefit of priority of U.S. Provisional Application No. 63/459,884 filed on Apr. 17, 2023, which is incorporated herein in its entirety by reference.

### BACKGROUND

### Field

The present patent application relates to a vehicle member assembly for use in an automobile and a method for manufacturing the same.

### Description of Related Art

Aluminum tailor welded blanks for cold forming may be generally joined by laser welding. That is, laser welding may be used to join aluminum tailor welded blanks having different thicknesses for cold forming. The laser welding may be also used to join tailor welded blanks with different aluminum grades for cold forming. FIG. 8 of the present patent application shows a prior art vehicle blank member assembly for use in an automobile in which a vehicle blank member is welded to another vehicle blank member by laser welding procedure to form the vehicle blank member assembly.

Characteristics of the laser weld joint may have a disadvantage for performance of the laser welded vehicle blank member assembly due to a geometric notch (e.g., either concave or convex) in the laser weld joint. The laser weld joint also may have a very tight section of diversified material mechanical property zone that may lead to inferior performance of the laser welded vehicle blank member assembly. Microstructure of the laser weld joint may include coarse grain structure, which typically may contribute to local corrosion issues, or poor performance of the laser welded vehicle blank member assembly (e.g., crack initiation). The residual stresses may also be higher in the laser weld joint. Parent/base materials may have short property transition from one sheet to the next sheet in the laser welding. Laser welding may potentially need a tighter trim edge quality. Depending on the parent/base materials/metals (higher strength e.g., 7xxx grades) aging may have a negative effect on the laser weld joint causing stress corrosion cracking.

The present patent application endeavors to provide various improvements over known methods for manufacturing a vehicle member assembly for use in an automobile.

### SUMMARY

In one embodiment of the present patent application, a method for forming a vehicle member assembly for use in an automobile is provided. The method comprises providing a plurality of vehicle blank members; welding each of the plurality of vehicle blank members to at least an adjacent vehicle blank member by friction stir welding to form weld joints between each of the vehicle blank members and at least the adjacent vehicle blank member so as to form a vehicle blank member assembly; and shaping the vehicle blank member assembly into a desired shape. Each vehicle blank member comprising aluminum. At least a portion of each weld joint comprises equiaxed, recrystallized grains that are flatter and smaller in comparison with grains of microstructure of portions of the vehicle blank members surrounding the weld joint.

In another embodiment of the present patent application, a vehicle member assembly for use in an automobile is provided. The vehicle member assembly comprises a plurality of vehicle blank members, and weld joints connecting each of the vehicle blank members to at least an adjacent vehicle blank member by friction stir welding to form the vehicle blank member assembly. Each vehicle blank member including aluminum. At least a portion of each weld joint comprises equiaxed, recrystallized grains that are flatter and smaller in comparison with grains of microstructure of portions of the vehicle blank members surrounding the weld joint. The vehicle member assembly is formed by shaping the vehicle blank member assembly into a desired shape.

These and other aspects of the present patent application, as well as the methods of operation and functions of the related elements of structure and the combination of parts and economies of manufacture, will become more apparent upon consideration of the following description with reference to the accompanying drawings, all of which form a part of this specification, wherein like reference numerals designate corresponding parts in the various figures. In one embodiment of the present patent application, the structural components illustrated herein are drawn to scale. It is to be expressly understood, however, that the drawings are for the purpose of illustration and description only and are not intended as a definition of the limits of the present patent application. It shall also be appreciated that the features of one embodiment disclosed herein can be used in other embodiments disclosed herein. As used in the specification and in the claims, the singular form of “a”, “an”, and “the” include plural referents unless the context clearly dictates otherwise. In addition, as used in the specification and the claims, the term “or” means “and/or” unless the context clearly dictates otherwise. It should also be appreciated that some of the components and features discussed herein may be discussed in connection with only one (singular) of such components, and that additional like components which may be disclosed herein may not be discussed in detail for the sake of reducing redundancy.

Other aspects, features, and advantages of the present patent application will become apparent from the following detailed description, the accompanying drawings, and the appended claims.

### BRIEF DESCRIPTION OF THE DRAWINGS

Various embodiments are disclosed, by way of example only, with reference to the accompanying schematic drawings in which corresponding reference symbols indicate corresponding parts, in which

FIG. 1 shows a vehicle blank member assembly and a vehicle member assembly for use in an automobile in accordance with an embodiment of the present patent application, where each of a plurality of vehicle blank members is welded to at least an adjacent vehicle blank member by friction stir welding to form weld joints therebetween so as to form the vehicle blank member assembly, and where the vehicle member assembly is formed by shaping the vehicle blank member assembly to have a desired shape;

FIG. 2 shows an exemplary vehicle blank member assembly in accordance with an embodiment of the present patent application, where the vehicle blank member is welded to an adjacent vehicle blank member by friction stir welding to form a friction stir weld joint therebetween;

FIGS. 3A and 3B show exemplary vehicle blank member assemblies in accordance with embodiments of the present patent application, where a vehicle blank member is welded to another vehicle blank member by friction stir welding to form a friction stir weld joint therebetween, where portions of one vehicle blank member and another vehicle blank member are positioned in an overlapping configuration with respect to each other to form overlapping friction stir weld joint;

FIG. 4 shows an exemplary vehicle blank member assembly in accordance with an embodiment of the present patent application, where a vehicle blank member is welded to an adjacent vehicle blank member by friction stir welding to form a friction stir weld joint therebetween, where portions of the vehicle blank member and the adjacent vehicle blank member are positioned in an end to end configuration (or adjacent to each other) to form butt friction stir weld joint;

FIG. 5 shows a method for forming a vehicle member assembly for use in an automobile in accordance with an embodiment of the present patent application;

FIGS. 6A and 6B show cross-sectional views of exemplary vehicle blank member assemblies in accordance with embodiments of the present patent application, FIGS. 6A and 6B each show a friction stir weld joint that comprises recrystallized grain structure and the portions of the vehicle blank members surrounding the friction stir weld joint;

FIGS. 7A and 7B show various microstructures of exemplary vehicle blank member assemblies in accordance with embodiments of the present patent application, where FIG. 7A shows microstructure of friction stir weld recrystallized grain nugget zone, microstructure of thermo-mechanically affected zone, microstructure of heat affected zone, and microstructure of the vehicle blank members surrounding the friction stir weld joint, where FIG. 7B shows microstructure of the vehicle blank members surrounding the friction stir weld joint, and microstructures of friction stir weld recrystallized grain nugget zone; and

FIG. 8 shows a prior art vehicle blank member assembly for use in an automobile, where a vehicle blank member is welded to an adjacent vehicle blank member by laser welding to form a laser weld joint therebetween so as to form the vehicle blank member assembly.

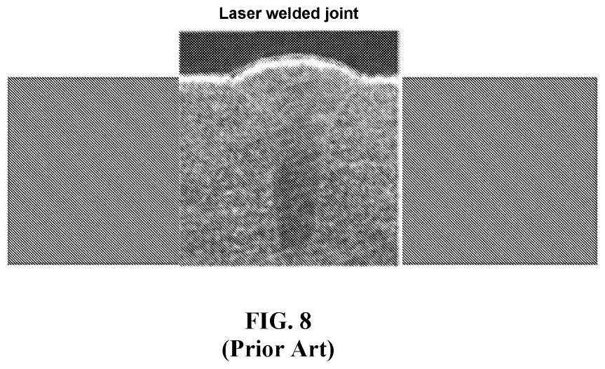

### DETAILED DESCRIPTION OF THE DRAWINGS

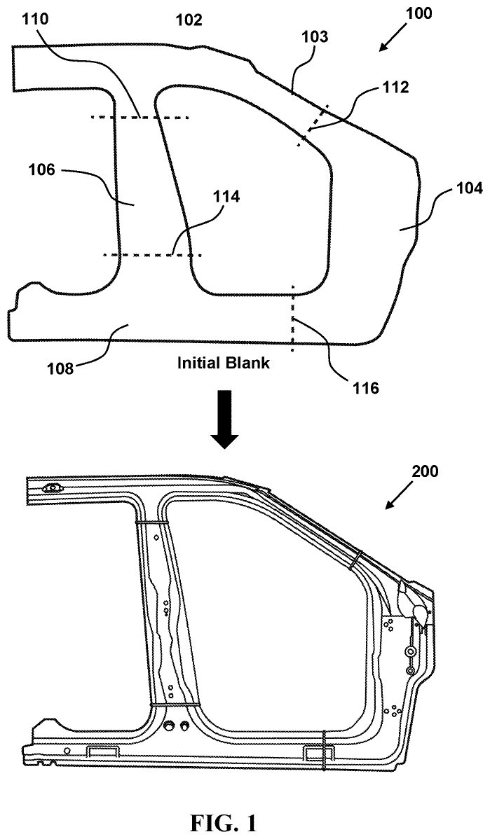

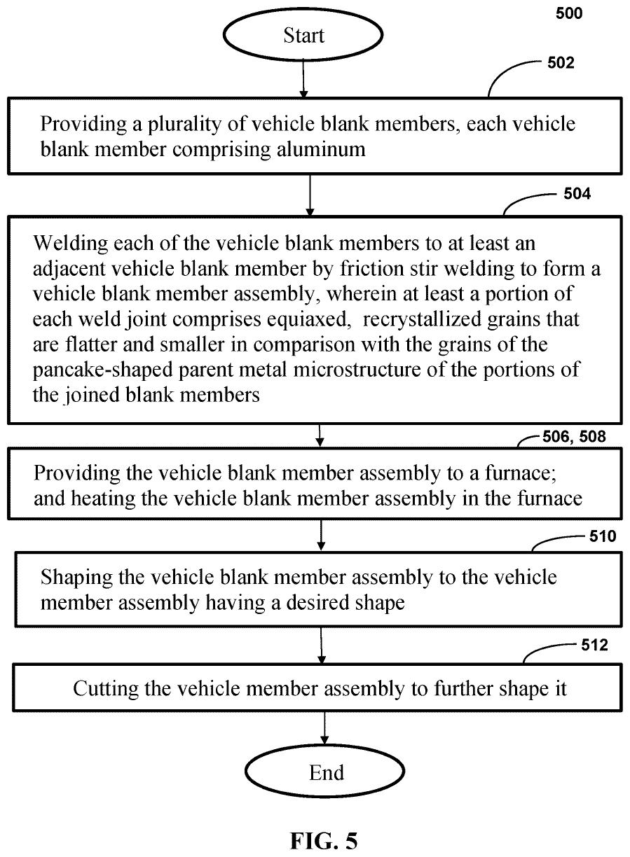

Referring to FIGS. 1 and 5, the present patent application provides a method 500 for forming a vehicle member assembly 200 for use in an automobile is provided. The method 500 comprises a procedure 502 for providing a plurality of vehicle blank members 102, 104, 106, and 108; a procedure 504 for welding each of the plurality of vehicle blank members 102, 104, 106, and 108 to at least an adjacent vehicle blank member 102, 104, 106, and 108 by friction stir welding to form weld joints 110, 112, 114, 116 between each of the vehicle blank members 102, 104, 106, and 108 and at least the adjacent vehicle blank member 102, 104, 106, and 108 so as to form a vehicle blank member assembly 100; and a procedure 510 for shaping the vehicle blank member assembly 100 into a desired shaped (and into the vehicle member assembly 200). Each vehicle blank member 102, 104, 106, and 108 comprising aluminum. At least a portion of each weld joint 110, 112, 114, 116 comprises equiaxed, recrystallized grains that are flatter and smaller in comparison with grains of microstructure of portions of the vehicle blank members 102, 104, 106, and 108 surrounding the weld joint 110, 112, 114, 116. The weld joints 110, 112, 114, 116 are friction stir weld joints.

The automobile may interchangeably be referred to as a vehicle. The automobile or vehicle may include any type of passenger or commercial automobile/vehicle such as a car, a truck, a sport utility vehicle, a crossover vehicle, a van, a minivan, a taxi, a bus, etc. The member may interchangeably referred to a component or a part.

The method 500 in FIG. 5 may begin/start with an uncoiling procedure that includes uncoiling an aluminum coil. An aluminum strip is uncoiled from the aluminum coil that may be subjected to cleaning, straightening, and passes over a looper, and a pinch roller into a blanking region. The method 500 in FIG. 5 may include a blanking procedure. The blanking procedure may be laser blanking that is performed by a laser system or on a traditional blanking press line. That is, the aluminum coil enters the blanking region, may be cut by a laser or other cutting head by way of the blanking process/procedure to form vehicle blank members or aluminum sheets with a required shape (e.g., with waste materials falling down and being conveyed to the outside). For example, as shown in FIG. 1, each of the vehicle blank members 102, 104, 106 and 108 may have different shapes. Also, as will be clear from the discussions below, each of the vehicle blank members 102, 104, 106 and 108 may have same or different grades of aluminum material, and each of the vehicle blank members 102, 104, 106 and 108 may have same or different material thicknesses.

The method 500 in FIG. 5 may also include an outputting procedure that includes outputting the vehicle blank members 102, 104, 106 and 108. The vehicle blank members 102, 104, 106 and 108 are received and conveyed by a conveyor, and then carried by means of a manipulator or a robot (e.g., with an external shaft) to a friction stir welder 300 or a friction stir welding station 310. This procedure may also be referred to as providing the vehicle blank members 102, 104, 106 and 108 to the friction stir welder 300 procedure.

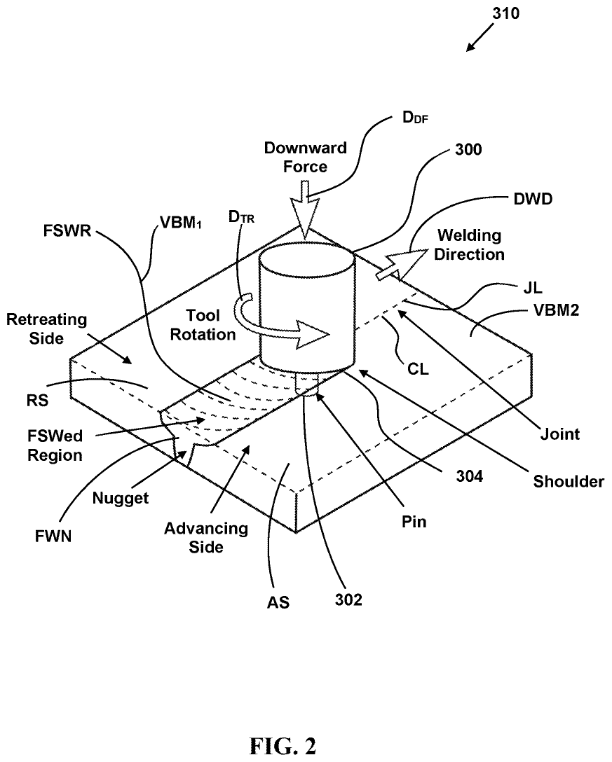

Friction stir welding is a solid state joining process. The materials, especially light metals, such as aluminum (Al) and its alloys, which cannot be welded properly by fusion welding can be welded effectively by the friction stir welding. Friction stir welding is also an advanced technique for joining materials in a continuous operation. Friction stir welding uses a non-consumable tool 300 (as shown in and described with respect to FIG. 2) to join two facing vehicle blank members.

In one embodiment, no filler material is added to form the friction stir weld joint. There may be some material loss and may be a risk of porosity (e.g., tunnel porosity) during the friction stir welding. The microstructure in the friction stir weld may have a fine grain structure/microstructure. The microstructure in the friction stir weld may be more homogeneous, providing a smooth transition of parent/base materials properties along the friction stir weld cross section. The decrease in mechanical properties are better in the friction stir weld joint than that of the laser weld joint. The edge quality greatly affects final geometric notch. The friction weld joint also provides smooth transition for different material gauges as discussed in detail below. More material varieties can be joined with less struggle compared to the laser welding. That is, properties and heat impact are easier to deal with using the friction stir welding.

Referring to FIG. 1, the joining/welding procedure used for forming the one-piece door ring 100 is friction stir welding. This joining/welding procedure may be used for forming other body structural components as described in detail below. The friction stir welding may be referred to as FSW.

The friction stir welding may be used to form the vehicle blank member assembly 100 that undergoes or is subjected to the cold forming/shaping procedure thereafter (i.e., cold forming/shaping performed after the friction stir welding). The friction stir welding may be used to form the vehicle blank member assembly 100 that undergoes or is subjected to the warm forming/shaping procedure thereafter (i.e., warm forming/shaping performed after the friction stir welding). The friction stir welding may be used to form the vehicle blank member assembly 100 that undergoes or is subjected to the hot forming/shaping procedure thereafter (i.e., hot forming/shaping performed after the friction stir welding). The friction stir welding and the cold, warm or hot forming/shaping procedures may be performed for various aluminum grades. The friction stir welding and the cold, warm or hot forming/shaping procedures may be performed for material/metal having various thickness

The friction stir welding station 310 may include devices (not shown) that are configured to clamp the two vehicle blank members for the friction stir welding. The devices may generally comprise an (e.g., large, horizontal) abutment/a support on which the two vehicle blank members to be friction stir welded are supported. The two vehicle blank members are mechanically clamped by (e.g., large) clamping members during the friction stir welding procedure. This clamp member may be designed to be fairly stable to withstand the large mechanical force generated during friction stir welding. Such a clamping member may include a screwed clamping jaw or a hydraulically driven clamping jaw.

Referring to FIG. 2, the friction stir welder 300 includes a rotating cylindrical tool that has profiled pin/probe 302 having diameter smaller than the diameter of a shoulder 304. The pin 302 may be slightly shorter than the required weld depth. The shoulder 304 is configured to ride atop the surface(s) of the vehicle blank member(s). During the friction stir welding, the friction stir welder 300 is fed into a joint (e.g., joint line JL in FIG. 2) between two clamped vehicle blank members, until the pin 302 pierces into the vehicle blank members and the shoulder 304 touches the surface of the vehicle blank members. The friction stir welder 300 may be interchangeably referred to as a tool, a cylindrical, shouldered tool, or a friction stir welding tool. The friction stir welder 300 may be a wear resistant tool.

In the friction stir welder 300, the advancing side AS lies where the linear velocity vector of the rotating tool and the welding direction are one and the same, whereas the retreating side RS lies where the linear velocity vector of rotating tool and the welding direction are opposite to each other. The advancing side AS of the friction stir welder 300 moves counter to the material flow during the friction stir welding. That is, the friction stir welder 300 has two sides relative to a centerline CL. The advancing side AS of the friction stir welder 300 is where the rotational motion and linear motion of the pin 302 are in the same direction. The retreating side RS is where the rotational motion and linear motion of the pin 302 are in the opposite directions. In the friction stir welding, the front portion of the moving friction stir welder 300 is the leading edge and the backside of the moving friction stir welder 300 is the trailing edge.

In the friction stir welding, the friction stir welder 300 with the pin 302 is rotated and slowly plunged/pierced into the joint line JL between two vehicle blank members, which are butted together. In another embodiment, the friction stir welder 300 with the pin 302 is rotated and slowly plunged/pierced into one of the two vehicle blank members, which are in an overlapping relationship with each other. The vehicle blank members may be clamped (e.g., using clamps described above) to prevent the abutting joint faces or overlapping faces from being forced apart during the friction stir welding process/procedure. Frictional heat is generated between the rotating friction stir welder 300 and the vehicle blank members to be joined. This heat causes the vehicle blank members to soften or melt, and allows traversing of the friction stir welder 300 along the joint line JL at the pre-set welding speed. That is, as the rotating friction stir welder 300 pierces down into the abutted or overlapped vehicle blank members the following things occur consecutively. The initial heat generation occurs owing to the friction between the pin 302 and the vehicle blank member(s); as the heat generation increases and the material of the vehicle blank members around the friction stir welder 300 softens, simultaneously the friction stir welder 300 gets heated. The plasticized material of the vehicle blank members is transferred from the leading edge to the trailing edge of the pin 302/friction stir welder 300 and is forged by the intimate contact of the shoulder 304 to produce a friction stir weld between the two vehicle blank members so as to form the vehicle blank member assembly.

The rotation speed of the friction stir welder 300 is the speed at which the friction stir welder 300 rotates in a rotating direction D_{TR}. The weld speed is the speed at which the friction stir welder 300 moves along a welding direction D_{WD}. FIG. 2 also shows, among other things, the advancing side AS of the friction stir welder 300, the retreating side RS of the friction stir welder 300, the friction weld nugget FWN, the friction stir weld region FSWR, the direction of rotation of the friction stir welder 300 D_{TR}, the direction of application of the downward force by the friction stir welder 300 D_{DF} and the direction of welding D_{WD}.

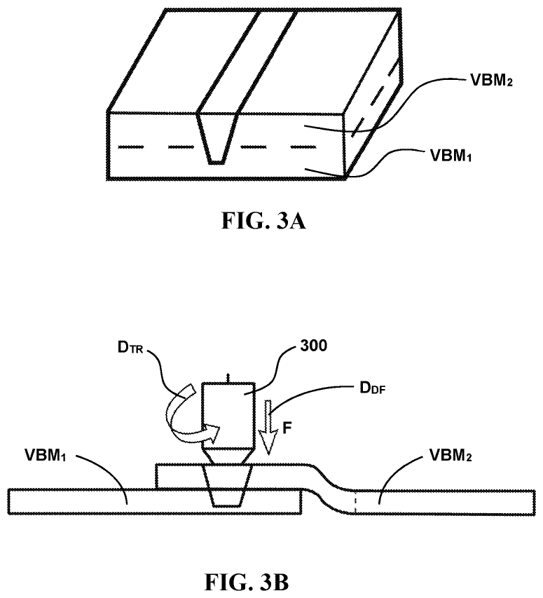

The friction stir welder 300 (as shown in FIG. 3) is configured to friction stir weld each of the plurality of vehicle blank members 102, 104, 106, and 108 to at least an adjacent vehicle blank member 102, 104, 106, and 108 by friction stir welding to form friction stir weld joints 110, 112, 114, 116 between each of the vehicle blank members 102, 104, 106, and 108 and at least the adjacent vehicle blank member 102, 104, 106, and 108 so as to form the vehicle blank member assembly 100.

In one embodiment, at least two vehicle blank members are adjacent. By adjacent, it is meant that the at least two vehicle blank members have edges or sides in abutment with each other. Adjacent assemblies include, for example, side-by-side confirmation, butt joint, lap joint, top of each other, overlapping configuration, tee-joint, edge joint, and corner joint.

In one embodiment, the vehicle blank member assembly 100 is a one-piece door ring. The one-piece door ring/vehicle blank member assembly 100 includes a rocker blank member 108, a roof rail blank member 102, a hinge pillar blank member 104, and a B-pillar blank member 106. In one embodiment, portions of the roof rail blank member 102 may be referred to as A-pillar blank member 103. In another embodiment, portions of the roof rail blank member 102 and the hinge pillar blank member 104 may be referred to as the A-pillar blank member 103.

The roof rail blank member 102 may be joined via the friction stir weld 110 to the B-pillar blank member 106 and may also be joined via the friction stir weld 112 to the hinge pillar blank member 104. Similarly, the B-pillar blank member 106 may be joined, on the top, via the friction stir weld 110 to the roof rail blank member 102 and may be joined, in the bottom, via the friction stir weld 114 to the rocker blank member 108. The rocker blank member 108 may be joined via the friction stir weld 114 to the B-pillar blank member 106 and may be joined via the friction stir weld 116 to the hinge pillar blank member 104. The hinge pillar blank member 104 may be joined via the friction stir weld 112 to the roof rail blank member 102 and may be joined via the friction stir weld 116 to the rocker blank member 108.

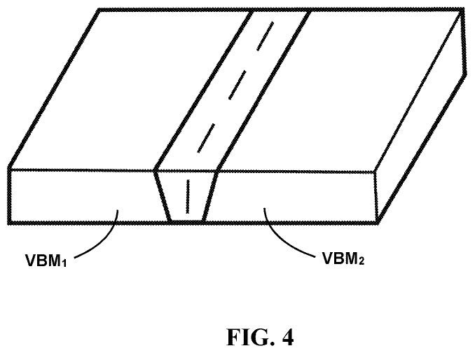

Referring to FIGS. 2 and 4, portions of the vehicle blank member VBM₁ and the adjacent vehicle blank member VBM₂ are positioned in an end/a side to end/side configuration (or adjacent to each other) to form butt friction stir weld joint. Referring to FIGS. 3A and 3B, portions of the vehicle blank member VBM₁ and the other vehicle blank member VBM₂ are positioned in an overlapping configuration with respect to each other to form overlapping friction stir weld joint.

In one embodiment, the vehicle blank member may include a base/main/parent blank and a patch blank attached to the base blank. In one embodiment, the base blank and the patch blank have the same thickness. In another embodiment, the base blank and the patch blank have different thicknesses. The thickness of the base blank and/or the patch blank may be in the range between 0.7 millimeters (mm) and 4.0 mm. In one embodiment, the base blank and the patch blank are made of the same material. The material of the base blank and the patch blank is aluminum. In another embodiment, the base blank and the patch blank are made of different materials. In one embodiment, the base blank and the patch blank are made of the same material grade. In another embodiment, the base blank and the patch blank are made of different material grades. The material grade of the base blank and the patch blank may be aluminum grade 5XXX. The material grade of the base blank and the patch blank may be aluminum grade 6XXX. Material. The material grade of the base blank and the patch blank may be aluminum grade 7XXX.

In one embodiment, the patch blank has an area smaller than the area of the base blank. In one embodiment, the patch blank is surrounded by portions (e.g., unpatched or remaining portions) of the base blank. In one embodiment, the portions of the base blank surrounding the patch blank are referred to as non-patched/unpatched portions or the remaining portions of the blank. In one embodiment, the patch blank is configured to overlap at least a portion of the base blank. In one embodiment, the patch blank is attached to the base blank by welding, adhesive or mechanical joining operation/procedure. In one embodiment, edge or internal portion of the patch blank is joined to the base blank using resistance spot welding (RSW), metal inert gas welding (MIG), laser welding, friction stir welding, self-piercing rivet (SPR) or flow drill screw (FDS) procedures. In one embodiment, the patch blank may be used to provide local reinforcements (i.e., with improved load transfer and/or distribution of stresses) to the vehicle blank member. In another embodiment, the patch blank is provided where greater strength, stiffness and Noise, vibration and harshness (“NVH”) performance are desired.

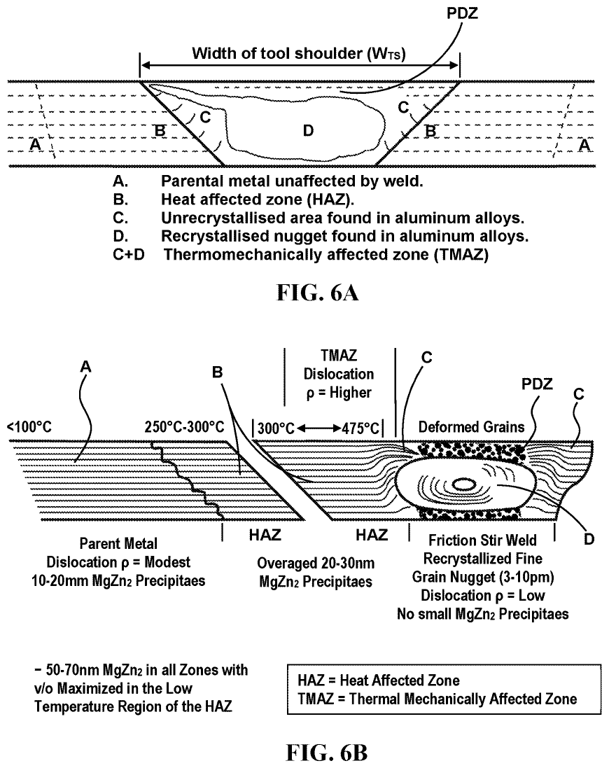

Referring to FIGS. 6A and 6B, the metallurgical structure inside and around the friction stir welded zone gives a very characteristic facet, which is significantly different from a facet obtained with the fusion weld. As shown in FIGS. 6A and 6B, zones A include parent/base metal/material that are unaffected by the friction stir welding. Zones A may be referred to as non-effected zones. As shown in FIG. 6B, the dislocation in the non-effected zones A is modest. Apart from the zones A that are remote from the friction stir weld and are completely unaffected, three to four distinct zones can be distinguished in the friction stir weld.

Zone D that is affected by the most severe plastic deformation may be referred to as the “nugget”. As shown in FIG. 6B, the dislocation in the zone D or the nugget is low. During the friction stir welding temperature range for these aluminum alloys is typically between 400 and 550 degrees Celsius. The grain size range in the FSW zone can vary depending on the specific welding parameters and the material being welded. However, in general, the grain size in the weld nugget, which is the highly deformed region at the center of the weld, is typically in the range of a few micrometers to a few tens of micrometers. This ultrafine-grained structure is a result of the intense plastic deformation that occurs during the FSW process. The width of the nugget is usually slightly more than the tool diameter. The zone D may also be referred to as stir zone or as dynamically recrystallized zone. The zone D is a region/zone of heavily deformed material that roughly corresponds to the location of the pin 302 during the friction stir welding. The grains within the zone D are roughly equiaxed and often an order of magnitude smaller than the grains in the parent/base material/metal. The zone D may also include several concentric rings, which may be due to variations in particle number density, grain size and texture.

Zone above the nugget/zone D may be referred to as the plastically deformed zone PDZ and is formed by the rotation effect of the tool shoulder 304. The plastically deformed zone PDZ may also be referred to as flow arm zone. This zone is on the upper surface of the friction stir weld and consists of material that is dragged by the shoulder 304 of the friction stir welder 300 from the retreating side RS of the friction stir weld, around the rear of the friction stir welder 300, and deposited on the advancing side AS of the friction stir weld.

Zone on each side of the nugget D may be referred to as the thermo-mechanically (or thermal mechanically) affected zone TMAZ, which is deformed to a lesser extent and which, depending on the alloy may show signs of recrystallisation. In one embodiment, as shown in FIGS. 6A and 6B, the TMAZ may include zone D and at least a portion of zone C. In one embodiment, the zone C may include unrecrystallized area found in the aluminum alloys and the zone D may include recrystallized nugget found in the aluminum alloys. As shown in FIG. 6B, the dislocation in the TMAZ is higher. In the TMAZ zone, the strain and temperature are lower and the effect of the friction stir welding on the microstructure is correspondingly smaller. Unlike the nugget/zone D, the microstructure in TMAZ is recognizably that of the parent/base material/metal, albeit significantly deformed and rotated. Although the term TMAZ technically refers to the entire deformed region, it is often used to describe any region not already covered by the terms zone D (and the flow arm zone/plastically deformed zone PDZ). PDZ next to nugget zone, typically has a finer grain structure than the base material, but not as fine as the grain structure in the nugget. The grain size in the thermo-mechanically affected zone can range from a few tens of micrometers to a few hundred micrometers, depending on the welding parameters and the cooling rate.

Heat-affected zone (HAZ) B surrounds the previous severely deformed zones and undergoes metallurgical transformations related to the increased temperature. The heat-affected zones B are positioned between the zones C and the non-affected zones A. The zone B is subjected to a thermal cycle but is not deformed during the friction stir welding. The temperatures in the zone B are lower than those in the zones C and D but may still have a significant effect if the microstructure is thermally unstable. FIG. 6A also shows the width of the tool shoulder W_{TS}. The HAZ, typically has a coarse-grained structure. The grain size in the HAZ can range from a few hundred micrometers to a few millimeters (few millimeters is being base material grain size as referenced), depending on the material and the welding parameters.

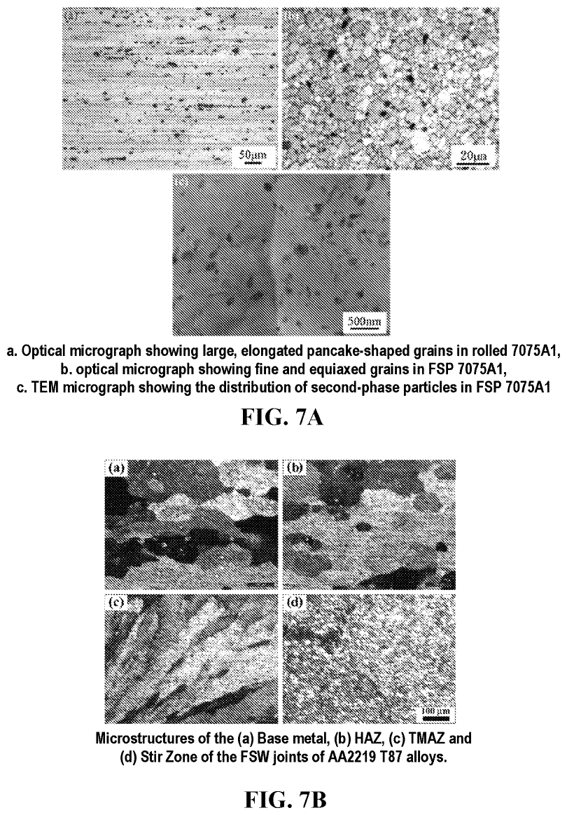

FIGS. 7A and 7B show various microstructures of exemplary vehicle blank member assemblies 100 in accordance with embodiments of the present patent application. For example, FIG. 7A shows (a) microstructure of the vehicle blank members (i.e., base/parent material/metal) surrounding the friction stir weld joint, (b) microstructure of the heat affected zone near the friction stir weld joint, (c) microstructure of the thermo-mechanically affected zone, and (d) microstructure of the friction stir weld recrystallized grain nugget zone. FIG. 7B shows optical micrographs showing (a) microstructure of the vehicle blank members (i.e., base/parent material/metal) surrounding the friction stir weld joint, while (b) and (c) microstructures of the friction stir weld recrystallized grain nugget zone. For example, (b) of FIG. 7B shows fine and equiaxed grains in the friction stir weld recrystallized grain nugget zone. As discussed above, the size of these fine and equiaxed grains in the friction stir weld recrystallized grain nugget zone are in the range between few micrometers to a few tens of micrometers. That is, the micrography of the friction stir weld zone (nugget) comprises a fine crystalline structure with a relatively homogenous grains. The grain size in the friction stir welded zone remains relatively homogenous and may be less than about reference base material grain size, so that good fatigue strength, improved toughness and satisfactory ductility may be obtained. In one embodiment, after the friction stir welding, solution heat treatment, quenching and/or annealing may be performed on the vehicle blank member assembly 100.

As discussed above, the microstructure within the weld nugget in which dynamic recrystallization (DRX) occurs consisted of grains that were much smaller and equiaxed. The terms equiaxed grains as used herein includes grains that have approximately equal dimensions in all directions. The term flatter as used herein refers to a flatter distribution of compared to the parent material in a grain-misorientation-angle-histogram for the DRX region. The (a) of FIG. 7B shows large, elongated pancake-shaped grains of the vehicle blank members (i.e., base/parent material/metal) surrounding the friction stir weld joint. As shown in FIGS. 7A and 7B, the microstructure within the friction stir weld nugget in which dynamic recrystallization occurs includes grains that were much finer/smaller and equiaxed ((b) of FIG. 7B) when compared to the severely-elongated and pancake-shaped parent/base metal/material microstructure ((a) of FIG. 7B). For example, the elongated “pancake-shaped” grains of the parent/base metal/material may be orientated along a rolling direction of the vehicle blank members.

The method 500 in FIG. 5 may also include an outputting procedure that includes outputting the vehicle blank member assembly 100. The vehicle blank member assembly 100 is received and conveyed by a conveyor, and then carried by means of a manipulator or a robot (e.g., with an external shaft) to a furnace, and then the vehicle blank member assembly 100 is placed into the furnace for either hot shaping/forming or warm shaping/forming. This procedure 506 may also be referred to as providing the vehicle blank member assembly 100 to the furnace procedure.

The method 500 in FIG. 5 may also include a procedure 508 in which the vehicle blank member assembly 100 is heated in the furnace, where the heating is performed prior to the shaping the vehicle blank member assembly 100 to form the vehicle member assembly 200.

In another embodiment, the heating procedure before the shaping procedure is optional. For example, when the vehicle blank member assembly 100 is shaped to form the vehicle member assembly 200 using a cold forming procedure, there is no heating procedure before the shaping procedure. Cold forming is a forging technique used to shape metal materials at near room temperature. Forming metal at cooler temperatures retains or enhances the tensile strength of the material while still allowing high levels of intricate manipulation. Cold forming is a high-speed process. When compared to hot forming methods, cold formed products are harder, produce greater yield, feature higher tensile strength, and have a superior surface finish. By using immense pressure to reform the vehicle blank member assembly, the grain structure of the material is compressed instead of removed, which improves the ultimate tensile strength of the final part.

The vehicle blank member assembly 100 is received and conveyed by a conveyor, and then carried by means of a manipulator or a robot (e.g., with an external shaft) to the shaping/forming die, and then the vehicle blank member assembly 100 is placed into the shaping/forming die for cold shaping/forming. In the cold forming/shaping procedure, the aluminum vehicle blank member assembly 100 is shaped in the shaping/forming die to provide the aluminum vehicle member assembly 200 with a desired shape.

When the vehicle blank member assembly 100 is shaped to form the vehicle member assembly 200 using the warm forming procedure or the hot forming procedure, the method 500 includes the heating procedure that is performed prior to the shaping the vehicle blank member assembly 100 to form the vehicle member assembly 200.

In one embodiment, the vehicle blank member assembly 100 is first heated to a predetermined temperature in the range between 50° and 550° C. for 5 to 30 minutes before the vehicle blank member assembly 100 undergoes the hot forming/shaping procedure, which is called hot forming die quenching. In one embodiment, the time at/above this predetermined temperature between 400 to 500° C.

In one embodiment, the vehicle blank member assembly 100 is first heated to a predetermined temperature in the range between 20° and 350° C. before the vehicle blank member assembly 100 undergoes the warm forming/shaping procedure. In one embodiment, the warm forming time can vary from several seconds to several minutes or even longer, depending on the size and complexity of the part being formed.

In one embodiment, the aluminum vehicle blank member assembly 100 is heated by convection heating (e.g., in the furnace). In another embodiment, the aluminum vehicle blank member assembly 100 is heated by jet heating (e.g., in the furnace).

In one embodiment, the aluminum vehicle blank member assembly 100 may be coated with a beat absorbing coating. The heat absorbing coating is configured to enhance and improve the heat absorption properties of the aluminum vehicle blank member assembly 100. The heat absorbing coating may include a heat resistant dark coating that is configured to allow for homogeneous heating of the aluminum vehicle blank member assembly 100. In another embodiment, the heat absorbing coating on the aluminum vehicle blank member assembly 100 may be optional. In one embodiment, the aluminum vehicle blank member assembly 100 may be pre-heated prior to heating in the main furnace to ensure homogeneous heating of the aluminum vehicle blank member assembly 100 and to ensure an optimum cycle time.

After the heating or warming procedure, the heated/warmed aluminum vehicle blank member assembly 100 is shaped to provide the aluminum vehicle member assembly 200 with a desired shape and/or strength. That is, the heated/warmed aluminum vehicle blank member assembly 100 is transferred immediately into a forming and cooling die to form/shape the aluminum vehicle blank member assembly 100 to achieve the desired shape and/or strength. In one embodiment, the aluminum vehicle blank member assembly 100 may be rapidly cooled down to an ambient temperature while shaping the aluminum vehicle blank member assembly 100 to achieve the desired strength. Overall, the strength variation of aluminum alloys after warm/hot forming compared to the T4 condition depends on several factors and must be evaluated on a case-by-case basis. The specific forming conditions and alloy properties must be carefully considered to ensure that the final product meets the desired strength and mechanical properties.

The forming die may include a forming/stamping die set. The die set may include a lower die and an upper die. The lower die and the upper die each may include a die member. The lower die member and the upper die member each may include a die surface. As used herein, the term “die surface” refers to the portion of the exterior surface of a die that forms a formed/stamped component. The die surfaces can cooperate to form a die cavity therebetween.

The forming and cooling die may also include a plurality of cooling channels. That is, the upper die and the lower die each include the plurality of cooling channels. Each cooling channel of the lower die member or the upper die member may be offset from the respective lower die surface or the respective upper die surface. For example, a hot forming/hot stamping die set is shown in and described in U.S. Pat. No. 8,215,147, which is incorporated by reference herein in its entirety.

The aluminum vehicle blank member assembly 100 can be placed in the die cavity between the die surfaces. The lower and upper dies may be brought together (i.e., closed) in a die action direction via a conventional stamping press to deform the aluminum vehicle blank member assembly 100 so as to form (and optionally trim) a stamped/formed component.

Cooling fluid, such as water, gas or other fluid medium, which can be provided by a cooling system (e.g., a cooling system that conventionally includes a reservoir/chiller and a fluid pump) can be continuously circulated through the cooling channels to cool the lower and upper dies. It will be appreciated by a person of ordinary skill in the art that the circulating cooling fluids are configured to cool the lower and upper dies and that the lower and upper dies are configured to quench and cool the warm/hot-stamped or warm/hot-formed component.

The stamping press is configured to maintain the lower and upper dies in a closed relationship for a predetermined amount of time to permit the aluminum vehicle blank member assembly 100 to be cooled to a desired temperature. The aluminum vehicle blank member assembly 100 is thus shaped while it is being cooled to provide the aluminum vehicle blank member assembly 100 with the desired shape and strength.

The method 500 in FIG. 5 may also include a procedure 512 in which the vehicle member assembly 200 may then be cut/trim to further shape it. The cutting/trimming of the vehicle member assembly 200 is carried out with the help of a laser cutting process (using a laser system) or the water jet cutting process (using a water jet system), by means of which high-quality trimming of the component/part edges may be achieved.

The hot or warm forming tool for the aluminum vehicle blank member assembly 100 may include all considerations engineered into the tool design to accommodate the vehicle blank members with the reinforced/patched area and/or the vehicle blank members with varying thicknesses. The tool cooling in the area of the reinforcement/patch and/or the joining area of the vehicle blank members with varying thickness may be adjusted and adequate to cool and quench the thicker area to achieve optimum cycletime.

The vehicle blank member assembly 100 of the present patent application may be an aluminum tailored welded blank member assembly 100. The vehicle blank member assembly 100 may be one-piece door ring 100 with multiple friction stir weld joints 110, 112, 114, 116 as shown in FIG. 1. The vehicle blank member assembly 100 may be any vehicle blank member assembly that may be shaped into other body structural component of the automobile.

As discussed above, the vehicle member assembly 200 may be a door ring assembly 200 as shown in FIG. 1. In one embodiment, the vehicle member assembly 200 may be any other body structural component of the automobile, including, A-Pillar, A-Pillar reinforcement member, side member, B-Pillar, B-Pillar reinforcement member, hinge pillar, roof rail member, header member, roof bow member, door ring member, double door ring member, front rail member, rear rail member, side reinforcement member, rocker rail member, rocker panel member, fire wall upper member, fire wall lower member, fire wall reinforcement member, tunnel member, tunnel reinforcement member, side impact beam front door member, side impact beam rear door member, etc.

In another embodiment, the vehicle member assembly 200 may be used for other body structural components of the automobile, including, standard Electric Vehicle (EV) specific components, Battery-powered Electric Vehicle (BEV) specific components, etc. For example, these EV or BEV specific components may include side member of battery tray, cross member of battery tray, reinforcement of battery tray, corner reinforcement member, battery tray cover member, battery tray cover reinforcement member, etc.

The thickness of the vehicle blank members 102, 104, 106, and 108 is commonly specified by a traditional, non-linear measure known as its gauge. For example, the larger the gauge number, the thinner the vehicle blank member. In one embodiment, the gauge of the vehicle blank members 102, 104, 106, and 108 that are being joined/friction stir welded to each other are the same. In another embodiment, the gauge of the vehicle blank members 102, 104, 106, and 108 that are being joined/friction stir welded to each other are different.

The vehicle blank member assembly 100 includes four vehicle blank members 102, 104, 106, and 108. In one embodiment, the gauges of the four vehicle blank members 102, 104, 106, and 108 are the same. In another embodiment, the gauges of the four vehicle blank members 102, 104, 106, and 108 are different. The vehicle blank member assembly 100 may be made from a single gauge, two different gauges, three different gauges, or four different gauges.

In the case of the vehicle blank members with variable thicknesses, joining/welding these vehicle blank members (with variable thicknesses) by using the friction stir welding provides a gradual transition of thickness from one vehicle blank member to the other vehicle blank member (e.g., compared to a laser welded joint). The thickness of the vehicle blank member may be in the range between 0.7 millimeters (mm) and 4.0 mm.

In one embodiment, the material grade of the vehicle blank members 102, 104, 106, and 108, which are being joined/friction stir welded to each other, is the same. In another embodiment, the material grades of the vehicle blank members 102, 104, 106, and 108, which are being joined/friction stir welded to each other, are different.

The vehicle blank member assembly 100 includes four vehicle blank members 102, 104, 106, and 108. In one embodiment, the material grade of the four vehicle blank members 102, 104, 106, and 108 is the same. In another embodiment, the material grades of the four vehicle blank members 102, 104, 106, and 108 are different. The vehicle blank member assembly 100 may be made from a single material grade, two different material grades, three different material grades, or four different material grades.

In the case of the vehicle blank members with variable material grades, joining/welding these vehicle blank members (with variable material grades) by using the friction stir welding provides a gradual transition of mechanical properties from one vehicle blank member to the other vehicle blank member (e.g., compared to a laser welded joint). The material of the vehicle blank members 102, 104, 106, and 108 is aluminum. The material grade of the vehicle blank members 102, 104, 106, and 108 may be aluminum grade 5XXX. The material grade of the vehicle blank members 102, 104, 106, and 108 may be aluminum grade 6XXX. The material grade of the vehicle blank members 102, 104, 106, and 108 may be aluminum grade 7XXX.

The present patent application and its various embodiments as described above uniquely address the observed, noted and researched findings and improve on the prior and current state of the art systems. The listed products, features and embodiments as described in the present patent application should not be considered as limiting in any way.

Although the present patent application has been described in detail for the purpose of illustration, it is to be understood that such detail is solely for that purpose and that the present patent application is not limited to the disclosed embodiments, but, on the contrary, is intended to cover modifications and equivalent arrangements that are within the spirit and scope of the appended claims. In addition, it is to be understood that the present patent application contemplates that, to the extent possible, one or more features of any embodiment can be combined with one or more features of any other embodiment.

The illustration of the embodiments of the present patent application should not be taken as restrictive in any way since a myriad of configurations and methods utilizing the present patent application can be realized from what has been disclosed or revealed in the present patent application. The systems, features and embodiments described in the present patent application should not be considered as limiting in any way. The illustrations are representative of possible construction and mechanical embodiments and methods to obtain the desired features. The location and/or the form of any minor design detail or the material specified in the present patent application can be changed and doing so will not be considered new material since the present patent application covers those executions in the broadest form.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Terms of degree such as “generally,” “substantially,” “approximately,” and “about” may be used herein when describing the relative positions, sizes, dimensions, or values of various elements, components, regions, layers and/or sections. These terms mean that such relative positions, sizes, dimensions, or values are within the defined range or comparison (e.g., equal or close to equal) with sufficient precision as would be understood by one of ordinary skill in the art in the context of the various elements, components, regions, layers and/or sections being described.

The foregoing illustrated embodiments have been provided to illustrate the structural and functional principles of the present patent application and are not intended to be limiting. To the contrary, the present patent application is intended to encompass all modifications, alterations and substitutions within the spirit and scope of the appended claims.

What is claimed is:

1. A method for forming a vehicle member assembly for use in an automobile, comprising:
providing a plurality of vehicle blank members, each vehicle blank member comprising aluminum;
welding each of the vehicle blank members to at least an adjacent vehicle blank member by friction stir welding to form weld joints between each of the vehicle blank members and at least the adjacent vehicle blank member so as to form a vehicle blank member assembly,
wherein at least a portion of each weld joint comprises equiaxed, recrystallized grains that are flatter and smaller in comparison with grains of microstructure of portions of the vehicle blank members surrounding the weld joint; and
shaping the vehicle blank member assembly into a desired shape.

2. The method of claim 1, wherein the shaping includes hot shaping or warm shaping, the shaping further includes:
providing the vehicle blank member assembly to a furnace; and
heating the vehicle blank member assembly in the furnace.

3. The method of claim 1, wherein the shaping includes hot shaping, cold shaping or warm shaping, and further comprising
cutting the vehicle member assembly to further shape it after the shaping.

4. The method of claim 3, wherein the cutting comprises laser cutting.

5. The method of claim 1, wherein the shaping comprises a warm shaping, a cold shaping or a hot shaping.

6. The method of claim 1, wherein the weld joints are friction stir weld joints.

7. The method of claim 2, wherein the shaping includes shaping the vehicle blank member assembly to have a desired strength.

8. The method of claim 1, wherein at least two of the blank members have a different thicknesses.

9. The method of claim 8, wherein the thicknesses of the at least two blank members of different thickness have thicknesses in the range between 0.7 millimeters (mm) and 4.0 mm.

10. The method of claim 1, wherein the plurality of vehicle blank members comprises vehicle blank members having variable material grades.

11. The method of claim 10, wherein the variable material grades comprises aluminum grades 5XXX, aluminum grades 6XXX, and/or aluminum grades 7XXX.

12. The method of claim 1, wherein the weld joints comprises overlap weld joints.

13. The method of claim 1, wherein the weld joints comprises butt weld joints.

14. A vehicle member assembly for use in an automobile, comprising:
a plurality of vehicle blank members, each vehicle blank member including aluminum, and
weld joints connecting each of the vehicle blank members to at least an adjacent vehicle blank member by friction stir welding to form the vehicle blank member assembly,
wherein at least a portion of each weld joint comprises equiaxed, recrystallized grains that are flatter and smaller in comparison with grains of microstructure of portions of the vehicle blank members surrounding the weld joint, and
wherein the vehicle member assembly is formed by shaping the vehicle blank member assembly into a desired shape.
